(19) United States
(12) Patent Application Publication
(10) Pub. No.: US 2014/0238178 A1
(43) Pub. Date: Aug. 28, 2014

(54) MACHINE WITH A TOOL MANIPULATOR

(71) Applicant: Janusz Marcin EJMA, Walcz (PL)

(72) Inventors: Janusz Marcin Ejma, Walcz (PL); Piotr Piaskowy, Walcz (PL)

(21) Appl. No.: 14/350,070

(22) PCT Filed: Oct. 8, 2012
(86) PCT No.: PCT/PL2012/000100

§ 371 Date: Apr. 5, 2014

(30) Foreign Application Priority Data
Oct. 10, 2011 (PL) P.396589

(51) Int. Cl. B23Q 1/44; B25J 11/00

(52) U.S. Cl. CPC B23Q 1/44; B25J 11/005
USPC 74/490.09

(57) ABSTRACT

The machine contains the machine's body (1) with guide (L) and the manipulator that consists of the first arm (A) and the second arm (B). Inside guide (L), situated at one of the sides of the machine's, body (1) the following elements, which constitute successive elements of the manipulator, are mounted: element (C1) that guides the end of the first arm (A) together with the first drive (A1) and element (C2) that guides the and of the second arm (B) together with the second drive (B1), whereas the opposite ends of the first arm (A) and the second arm (B) are joined together with each other in the self-aligning manner. The movement range of the tool's socket (2), as delineated by area (P), which constitutes a rectangle with sides (X) and (Y), where side (X) is parallel to guide (L).

The subject of this invention is a machine with a tool manipulator, especially for high-precision tools, which can find its applications for instance in designs of flat metal sheet cutting machines equipped with a laser tool.

The most popular solutions that have been used so far in designs of surface processing machines, most frequently used to process metal sheets, contain the tool's head that is placed in the manipulator that is mounted in guides that are situated in the cross-bar, whereas the cross-bar is mounted in the guides that are situated in the machine's body. The cross-bar may be equipped with drives at its both sides, only at one side of the cross-bar, or with one drive transmitted to both sides of the cross-bar. The tool's head moves in axis Z that is oriented in the upwards/ downwards direction, and, while moving in this way, the tool's head approaches towards or moves away from the material being processed, whereas in other similar solutions, the material approaches towards the fixed tool's head in axis Z. The direction of movement of the tool's head in axis X, which is situated at the horizontal plane, is executed by movement of the cross-bar that is supported at both sides on the machine's single- or multi-component body. Movement of the tool's head in axis Y, which is situated at the horizontal plane, is executed by the drive of the manipulator that is mounted at the cross-bar. The drive of axis Y is moved together with the cross-bar along axes X and Y.

From the application for the European Patent EP 283963A1, we know designs of flat metal sheet cutting machines, in which the cross-bar is suspended under one beam that goes through the machine's body. Such solutions make it possible to save both on the processing of details and the material necessary to produce them, since, in order to produce them, only the place where the cross-bar is suspended under the machine's body is precisely processed, and only one motor is used in axis X, in the middle of cross-bar Y. In the claim for the European Patent EP 283963A1, a solution was presented with a single arm that constitutes a kind of a cross-bar that is supported in the slidable manner within the machine's body.

Due to the similar principle of their operation, one of the features of all the above solutions is the occurrence of forces and bending moments resulting from heavy weight of the cross-bar itself, as well as from the weight of the cross bar-mounted elements that are necessary for the tool manipulator to work in axis Y, such as for instance axis Y motors, guides, and from the weight of the'tool's head. Up till now, problems of this kind have been solved by using increasingly heavy and increasingly stiff cross-bars and machine bodies. Another way to eliminate the effects of emergence of unfavourable forces and bending moments is to lower the machine's dynamics, which results in its falling efficiency.

The objective of this invention is to design a machine featuring lightweight construction and high reliability, with the machine's dynamics being comparable to that of the machines that have been used to-date.

The essence of the machine's design, which, according to this invention, contains the machine's body with its guide, and the manipulator that consists of the arms, including their drives, and the tool's socket, as well as the material fixing area situated in the movement range of the tool's socket, is that inside the guide that is situated at one of the sides of the machine's body, the following elements of which the manipulator consists are mounted: the element that guides the end of the first arm together with the first drive, and the element that guides the end of the second arm together with the second drive, whereas the opposite ends of the first arm and the second arm are joined together with each other in the self-aligning manner. According to another beneficial feature of this invention, for the movement range of the tool's socket as delineated by area P, which constitutes a rectangle with sides X and Y, where side X is parallel to the guide of guiding elements, the length of at least one of the arms is higher than or equal to the length of side Y, which is determined by relation L1>=Y and/or L2>=Y, where L1 is the length of the first arm, and L2 is the length of the second arm. In line with another beneficial feature of this invention, for the movement range of the tool's socket, as delineated by area P, which constitutes a rectangle with sides X and Y, where side X is parallel to the guide of guiding elements, the length of the guide is higher than or equal to the sum of lengths of both arms and side X, which is determined by relation L1+L2+X<=L3, where L1 is the length of the first arm, and L2 is the length of the second arm. In line with the next beneficial feature of this invention, the material fixing area is connected with the machine's body that constitutes a mobile connection. According to another beneficial feature of this invention, the mobile connection contains drive. In line with another beneficial feature of this invention, the tool's socket is mounted in the axis of the self-aligning connection of the first arm with the second arm. In line with the next beneficial feature of this invention, the tool's socket is mounted at one of the arms, outside the place of the self-aligning connection of the first arm with the second arm.

A beneficial effect of making use of this invention is a new design of the machine, which features lightweight construction and high reliability, and its dynamics is comparable to that of machines that have been used so far. This effect has been achieved in such a way that in the solution according to this invention there only occur axial forces at the arms, whereas bending moments have been eliminated thus making it possible to eliminate the cross-bar, which, in to-date solutions, was moving along axis Y, together with the tool socket mounted at the cross-bar, and in this way the motor required to move the guides and all the other necessary elements along axis Y have also been eliminated.

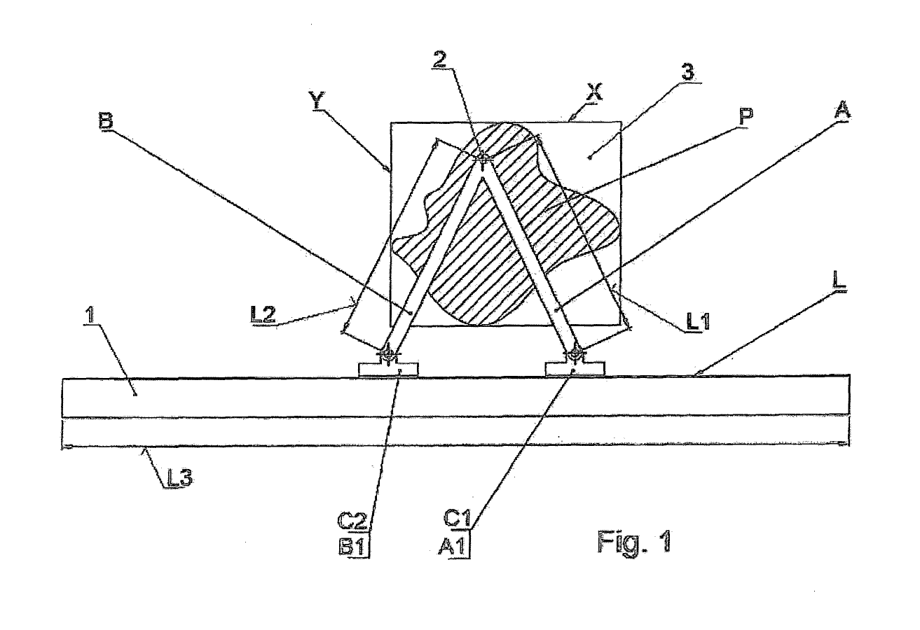

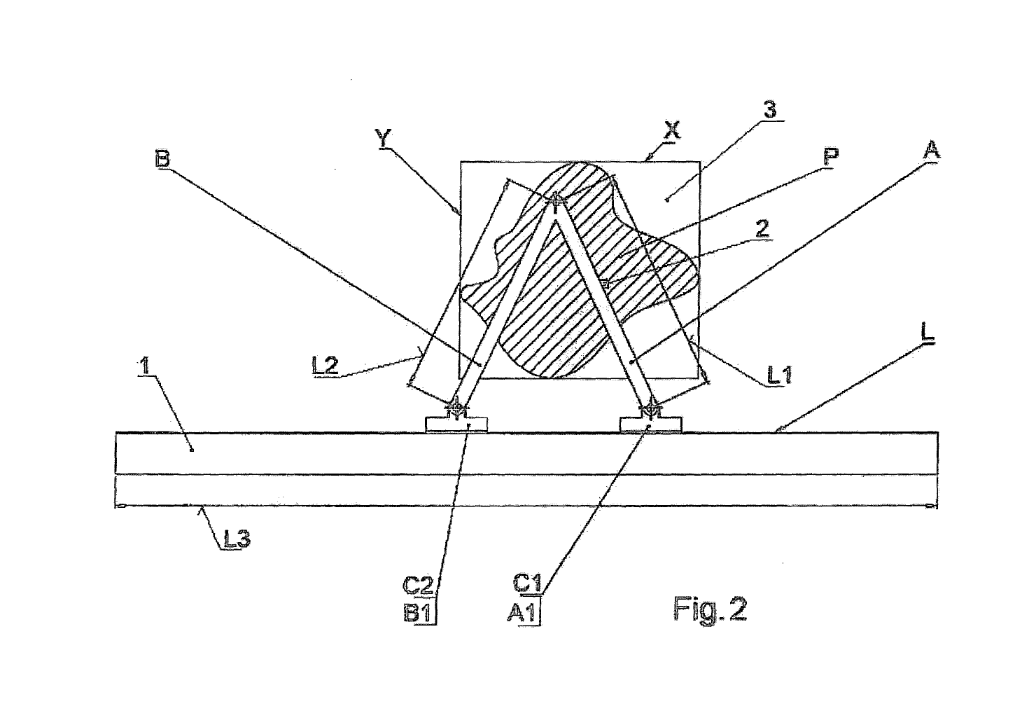

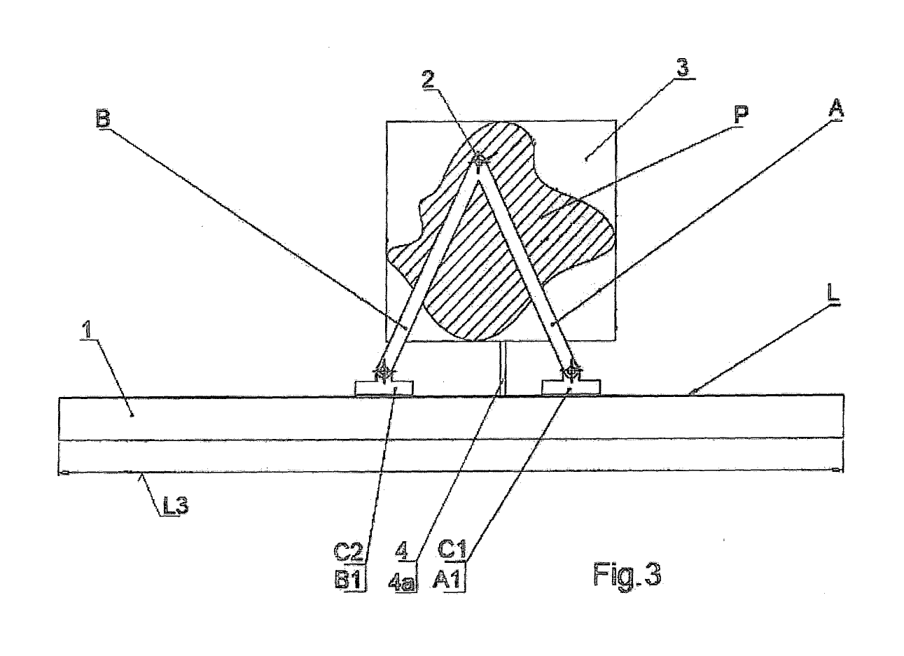

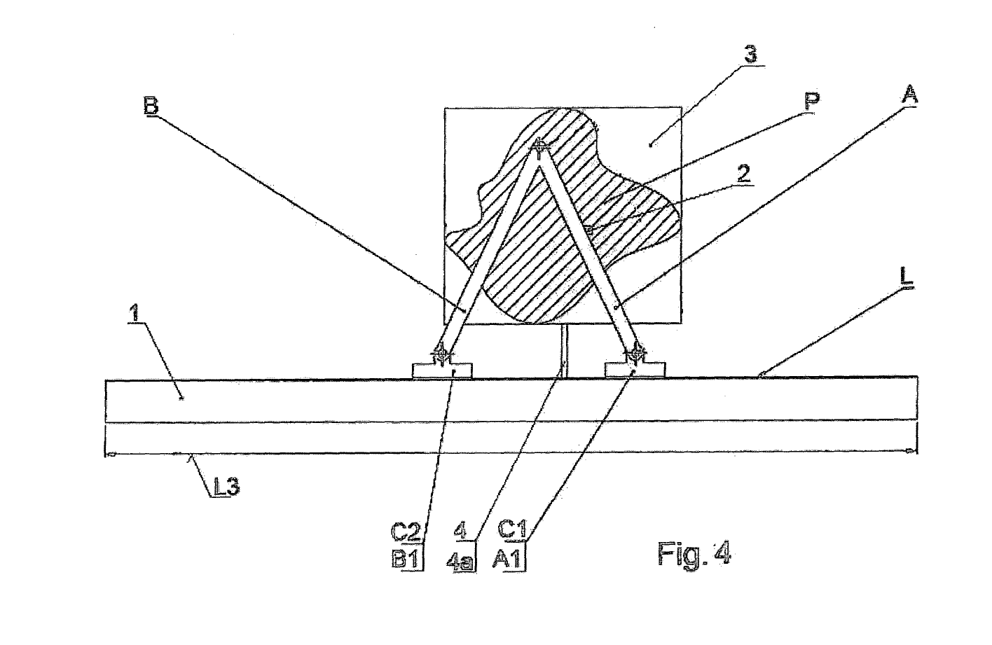

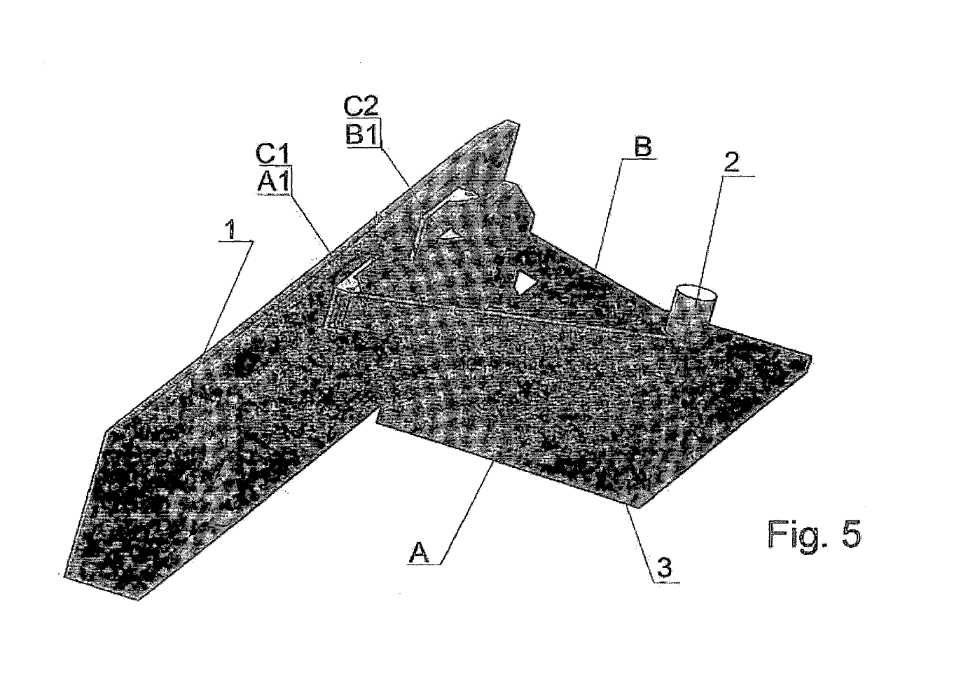

In the examples of its embodiments, the invention is clarified in the drawing that illustrates the machine's layout according to examples 1 and 3, FIG. 2 shows the layout of the machine according to examples 2 and 4, a FIG. 3 shows the layout of the machine according to example 5,furthermore, FIG. 4 shows the layout of the machine according to example 6,and FIG. 5 shows the layout of the solution according to this invention in the spatial arrangement.

### EXAMPLE 1

The machine according to the first of its exemplified embodiments contains the machine's body 1 with guide L. and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The movement range of the tool's socket 2 as delineated by area P, which constitutes a rectangle with sides X and Y, where side X is parallel to guide L of guiding elements C1 and C2, the length of arms A and B is equal to the length of side Y—which is determined by relation L1=Y and L2=Y, where L1 is the length of the first arm A, and L2 is the length of the second arm B. The tool's socket 2 is mounted in the axis of the self-aligning connection of the first arm A with the second arm B. The material fixing area 3 is connected with the machine's body 1 in the immobile manner.

### EXAMPLE 2

The machine according to the second of its exemplified embodiments contains the machine's body 1 with guide L and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The movement range of the tool's socket 2 as delineated by area P, which constitutes a rectangle with sides X and Y, where side X is parallel to guide L of guiding elements C1 and C2, the length of arm A is higher than the length of side Y, whereas the length of arm B is equal to the length of side Y—which is determined by relations L1>Y and L2=Y, where L1 is the length of the first arm A, and L2 is the length of the second arm B. The tool's socket 2 is mounted at the first arm A, outside the place of the self-aligning connection of the first arm A with the second arm B. The material fixing area 3 is connected with the machine's body 1 in the immobile manner.

### EXAMPLE 3

The machine according to the third of its exemplified embodiments contains the machine's body 1 with guide L and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The movement range of the tool's socket 2 as delineated by area P, constitutes a rectangle with sides X and Y, where side X is parallel to guide L of guiding elements C1 and C2, length L3 of guide L is equal to the sum of lengths of both arms (A) and (B) and side X—which is determined by relation L1+L2+X=L3, where L1 is the length of the first arm A, and L2 is the length of the second arm B. The tool's socket 2 is mounted at the first arm A, outside the place of the self-aligning connection of the first arm A with the second arm B. The material fixing area 3 is connected with the machine's body 1 in the immobile manner.

### EXAMPLE 4

The machine according to the fourth of its exemplified embodiments contains the machine's body 1 with guide L and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The movement range of the tool's socket 2, as delineated by area P, constitutes a rectangle with sides X and Y, where side X is parallel to guide L of guiding elements C1 and C2, length L3 of guide L is higher than the sum of lengths of both arms A and B and side X—which is determined by relation L1+L2+X<L3, where L1 is the length of the first arm A, and L2 is the length of the second arm B. The tool's socket 2 is mounted in the place of the self-aligning connection of the first arm A with the second arm B. The material fixing area 3 is connected with the machine's body 1. The material fixing area 3 is connected with the machine's body 1 in the immobile manner.

### EXAMPLE 5

The machine according to the fifth of its exemplified embodiments contains the machine's body 1 with guide L and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The tool's socket 2 is mounted in the place of the self-aligning connection of the first arm A with the second arm B. The material fixing area 3 is connected with the machine's body 1 that constitutes a mobile connection 4, which contains drive 4a.

### EXAMPLE 6

The machine according to the sixth of its exemplified embodiments contains the machine's body 1 with guide L and the manipulator that consists of the first arm A and of the second arm B. Inside guide L, situated at one of the sides of the machine's body 1, the following elements, which constitute successive elements of the manipulator, are mounted: element C1 that guides the end of the first arm A together with the first drive A1, and element C2 that guides the end of the second arm B together with the second drive B1, whereas the opposite ends of the first arm A and of the second arm B are joined together with each other in the self-aligning manner. The tool's socket 2 is mounted at the first arm A, outside the place of the self-aligning connection of the first arm A with the second arm B. The material fixing area 3 is connected with the machine's body 1 that constitutes a mobile connection 4, which contains drive 4a.

Regardless of the particular example of this invention's embodiment, the first drive A1 and the second drive B1 may be provided by linear motors or by systems in which electric motors or pneumatic or hydraulic servo-motors are used. All sorts of tools can be seated in tool sockets in each of the solutions as exemplified above; in particular, heads of a water, plasma or gas contour band saw, or cutting plotter heads.

1. Machine with a tool manipulator, especially for high-precision tools, which contains the machine's body with its guide and the manipulator that consists of the arms, including their drives, and the tool's socket, as well as the material fixing area situated in the movement range of the tool's socket, wherein inside guide (L), situated at one of the sides of the machine's body (1), the following elements, of which the manipulator consists, are mounted: element (C1) that guides the end of the first arm (A) together with the first drive (A1) and element (C2) that guides the end of the second arm (B) together with the second drive (B1), whereas the opposite ends of the first arm (A) and the second arm (B) are joined together with each other in the self-aligning manner.

2. Machine with a tool manipulator according to claim 1, wherein for the movement range of the tool's socket (2), as delineated by area P, which constitutes a rectangle with sides X and Y, where side X is parallel to the guide (L) of guiding elements and (C1) and (C2), the length of at least one of the arms (A) and (B) is higher than or equal to the length of side Y, which is determined by relation L1>=Y and/or L2>=Y, where L1 is the length of the first arm (A), and L2 is the length of the second arm (B).

3. Machine with a tool manipulator according to claim 1, wherein for the movement range of the tool's socket (2), as delineated by area P, which constitutes rectangle with sides X and Y, where side X is parallel to guide (L) of guiding elements (C1) and (C2), length L3 of guide (L) is higher than or equal to the sum of the lengths of both arms (A) and (B) and side X, which is determined by relation L1+L2+</=L3, where L1 is the length of the first arm (A), and L2 is the length of the second arm (B).

4. Machine with a tool manipulator according to claim 1, wherein the material fixing area (3) is connected with the machine's body (1) that constitutes a mobile connection (4).

5. Machine with a tool manipulator according to claim 4, wherein the mobile connection (4) contains drive (4a).

6. Machine with a tool data according to claim 1 wherein the tool's socket (2) is mounted in the place of the self-aligning connection of the first arm (A) with a second arm (B).

7. Machine with a tool manipulator according to claim 1 wherein the tool's socket (2) is mounted at one of the arms (A) or (B), outside tile place of the self-aligning connection of the first arm (A) with the second arm (B).
